(19) United States
(12) Patent Application Publication
(10) Pub. No.: US 2015/0036979 A1
(43) Pub. Date: Feb. 5, 2015

(54) OPTICAL FIBER CONNECTOR AND MOLD AND METHOD FOR MOLDING SAME

(71) Applicant: HON HAI PRECISION INDUSTRY CO., LTD., New Taipei (TW)

(72) Inventor: PO-WEI HUANG, New Taipei (TW)

(21) Appl. No.: 14/444,550

(22) Filed: Jul. 28, 2014

(30) Foreign Application Priority Data
Jul. 31, 2013 (TW) 102127370

(51) Int. Cl. G02B 6/38; B29D 11/00; B29C 45/36

(52) U.S. Cl. CPC G02B 6/3881; B29C 45/36; B29D 11/0075; B29L 2011/0075
USPC 385/77; 425/577; 264/1.25

(57) ABSTRACT

Optical fiber connector includes a main body and at least one protrusion. The main body includes a first surface, a second surface, and at least one receiving hole defined therein. Each protrusion is positioned on the first surface and surrounds an opening of the corresponding receiving hole.

### FIELD

The present disclosure relates to an optical fiber connector and a mold and a method for molding the optical fiber connector.

### BACKGROUND

Optical fiber connectors are configured to receive and fix end portions of optical fibers. An optical fiber connector defines a number of receiving holes passing through two opposite surfaces thereof, and each receiving hole receives an end portion of a corresponding optical fiber therein.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is an isometric view of an embodiment of an optical fiber connector.

FIG. 2 is another isometric view of the optical fiber connector of FIG. 1.

FIG. 3 is an enlarged view of area III of FIG. 1.

FIG. 4 is an exploded, isometric view of an embodiment of a mold for manufacturing the optical fiber connector.

FIG. 5 is another exploded, isometric view of the mold of FIG. 4.

FIG. 6 is a cross sectional view of the mold of FIG. 4 when manufacturing the optical fiber connector of FIG. 1.

FIG. 7 is an enlarged view of area VII of FIG. 6.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a number of” mean “at least two.” The references “outside” refer to a region that is beyond the outermost confines of a physical object. The references “substantially” are defined to be essentially conforming to the particular dimension, shape or other word that substantially modifies, such that the component need not be exact. The references “comprising,” when utilized, mean “including, but not necessarily limited to”; it specifically indicates open-ended inclusion or membership in the so-described combination, group, series and the like.

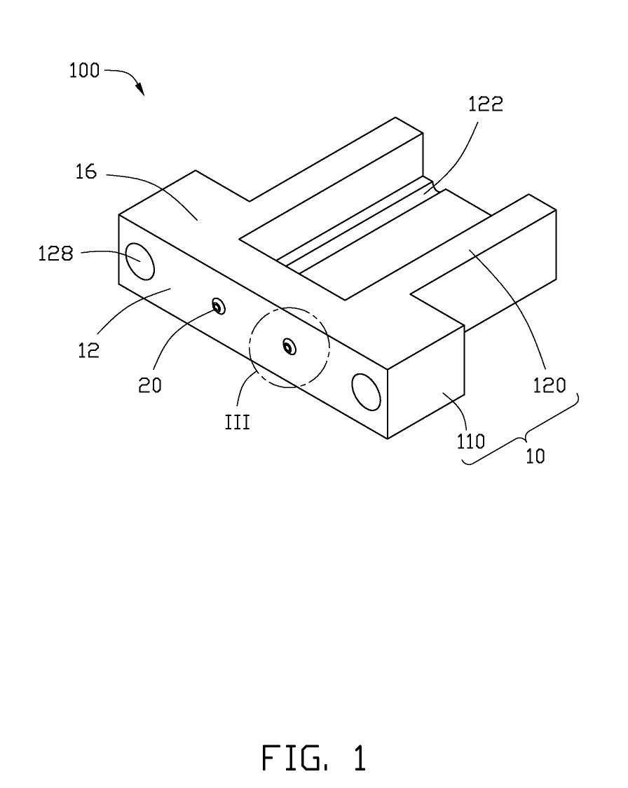

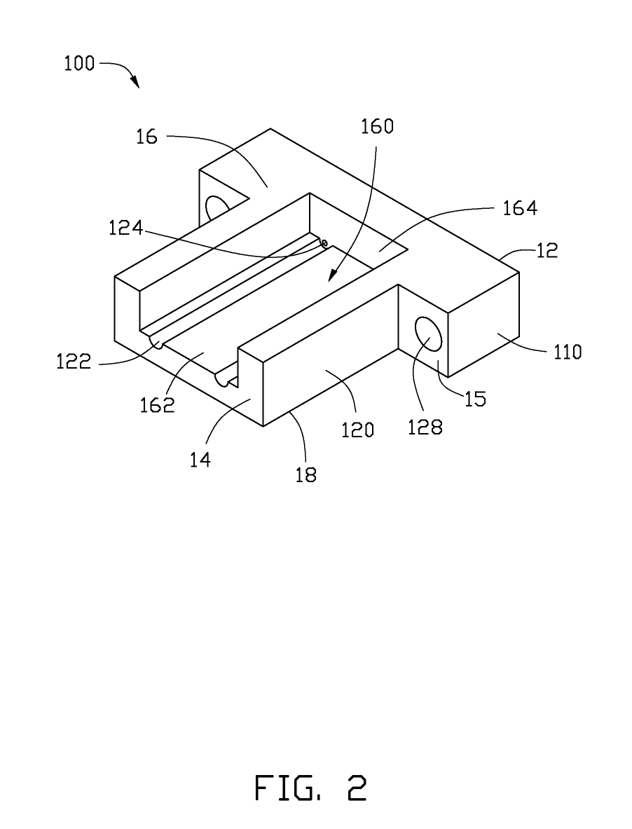

FIG. 1 and FIG. 2 illustrate an embodiment of an optical fiber connector 100. The optical fiber connector 100 includes a main body 10 and two protrusions 20. The main body 10 is configured to receive and fix end portions of optical fibers (not shown).

The main body 10 includes a first portion 110 and a second portion 120. The second portion 120 extends substantially perpendicular from a substantially middle portion of the first portion 110. The first portion 110 and the second portion 120 cooperatively form a substantially T-shaped block. The first portion 110 includes a first surface 12, and the second portion 120 includes a second surface 14. The first portion 110 further includes two third surfaces 15 opposite to the first surface 12, and the second portion 120 is located between the two third surfaces 15. The first surface 12, the second surface 14, and the two third surfaces 15 are substantially parallel to each other. The first portion 110 and the second portion 120 cooperatively form an upper surface 16 and a lower surface 18. The upper surface 16 and the lower surface 18 are opposite surfaces of the main body 10. The first surface 12, the second surface 14, and the two third surfaces 15 are substantially perpendicular to the upper surface 16 and the lower surface 18.

The main body 10 defines a recess 160 in the upper surface 16. The recess 160 passes through the second surface 14. The recess 160 includes a bottom surface 162 and a connecting surface 164. The bottom surface 162 is substantially parallel to the upper surface 16. The connecting surface 164 is substantially perpendicularly connected between the bottom surface 162 and the upper surface 16.

The main body 10 further defines two receiving grooves 122 and two receiving holes 124. The two receiving grooves 122 are defined in the bottom surface 162, and a cross-section of each receiving groove 122 is substantially semi-circular. The two receiving grooves 122 pass through the second surface 14 and extend to the connecting surface 164. The two receiving holes 124 are substantially circular and pass through the connecting surface 164 and the first surface 12. A diameter of each receiving hole 124 is smaller than a diameter of each receiving groove 122. Each receiving groove 122 is aligned to a corresponding receiving hole 124. Each receiving groove 122 and the corresponding receiving hole 124 are configured to cooperatively receive an end portion of a corresponding optical fiber.

The optical fiber includes an optical fiber core, and a cladding layer covered around the optical fiber core. The optical cladding layer is peeled from an end portion of the optical fiber to expose a portion of the optical fiber core. Each receiving hole 124 is configured to receive the exposed portion of the corresponding optical fiber core, and each receiving groove 122 is configured to receive a portion of the optical fiber with the cladding layer.

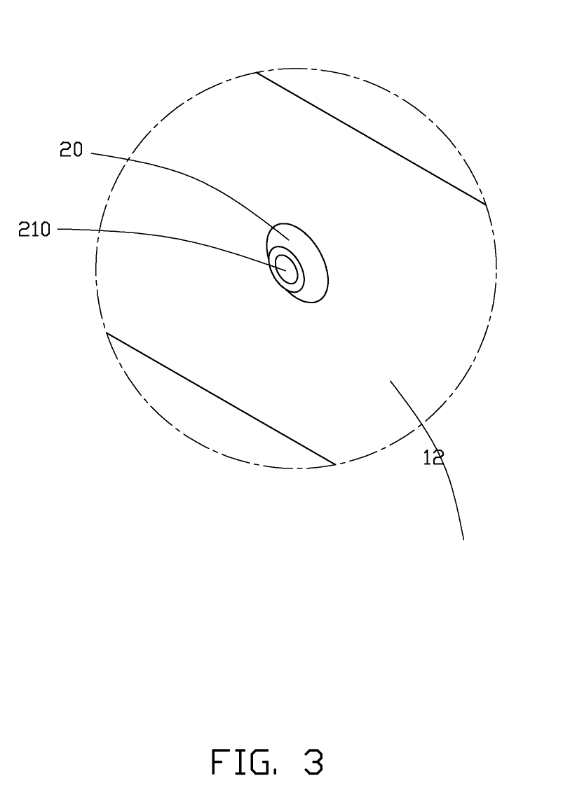

FIG. 3 illustrates that the two protrusions 20 are located on the first surface 12. The two protrusions 20 protrude away from the second surface 14. Each protrusion 20 is a substantially circular truncated cone, and each protrusion 20 axially defines a hole 210. A wide portion of each protrusion 20 surrounds an opening of the corresponding receiving hole 124 on the first surface 12, and each hole 210 fluidly communicates with the corresponding receiving hole 124. A diameter of the hole 210 is substantially the same as the diameter of the receiving hole 124. The hole 210 can receive an end portion of the optical fiber core passing through the receiving hole 124. In at least one embodiment, the main body 10 further defines two locating holes 128. Each locating hole 128 passes through the first surface 12 and the corresponding third surface 15. The two protrusions 20 are located between the two locating holes 128. The number of the protrusions 20 and of the receiving holes 124 are not limited by this embodiment. In other embodiments, the numbers of the protrusions 20 and of the receiving holes 124 can be changed.

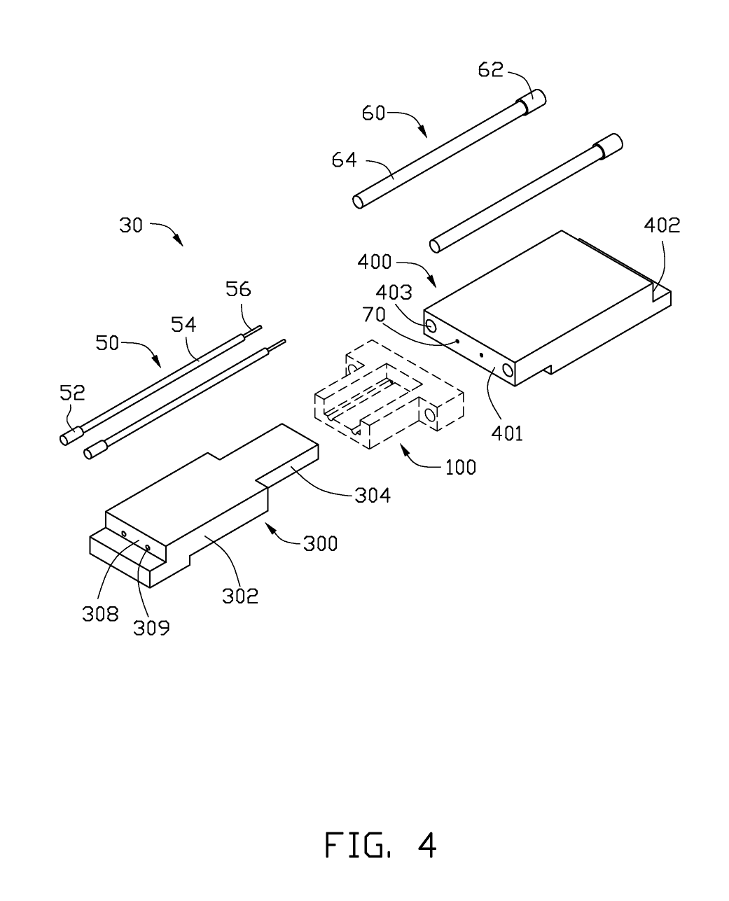

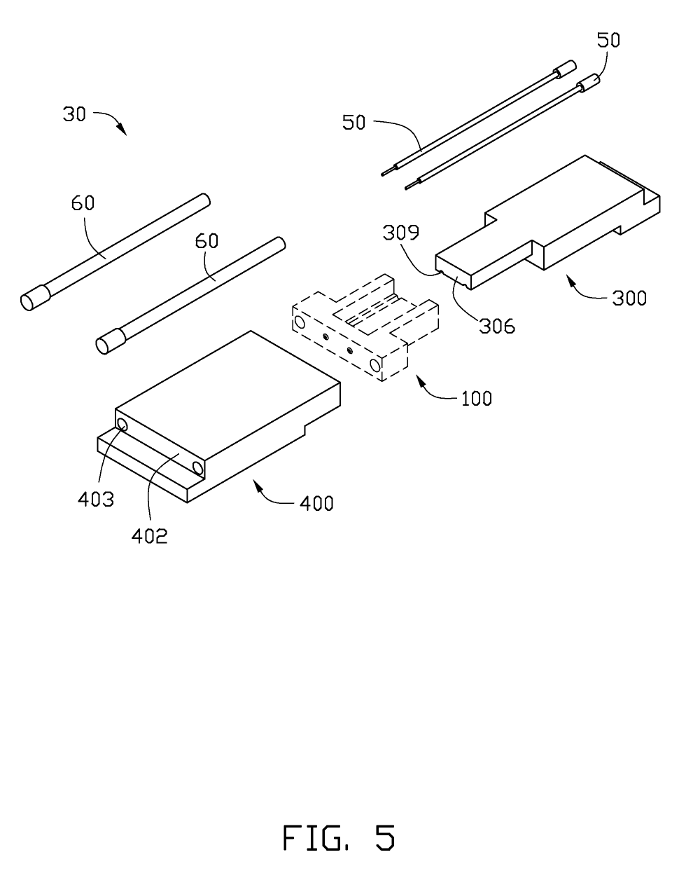

FIGS. 4-7 illustrate an embodiment of a mold 30 for molding the optical fiber connector 100. The mold 30 includes a first sliding block 300, two first insert cores 50, a second sliding block 400, and two second insert cores 60.

The first sliding block 300 includes a securing portion 302, a molding portion 304, a first front surface 306, and a first back surface 308. The molding portion 304 extends from the securing portion 302. The first front surface 306 is located on the molding portion 304, and the first back surface 308 is located on the securing portion 302. The first front surface 306 is substantially parallel to the first back surface 308. The sliding block 300 defines two first through holes 309 passing through the first front surface 306 and the first back surface 308. Each first through hole 309 includes a securing hole (not labeled), and a molding hole (not labeled) extending continuously from the corresponding securing hole. Each securing hole extends through the securing portion 302, and each molding hole extends through the molding portion 304. A cross-section of each securing hole is substantially circular. Each molding hole is exposed through a bottom surface of the molding portion 304. Thus, a cross-section of each molding hole is substantially semi-circular, and each molding hole is exposed to the outside.

Each first insert core 50 is substantially cylindrical. Each first insert core 50 includes a back end portion 52, a main portion 54, and a penetrating portion 56. The main portion 54 is located between the back end portion 52 and the penetrating portion 56. A diameter of the back end portion 52 is greater than a diameter of the main portion 54, and the diameter of the main portion 54 is greater than a diameter of the penetrating portion 56. Each first insert core 50 is inserted through the first sliding block 300, such that the main portion 54 is received in the corresponding first through hole 309, the back end portion 52 abuts the first back surface 308, and the penetrating portion 56 protrudes out of the first front surface 306 through the corresponding first through hole 309. A portion of each main portion 54 received in the corresponding molding hole is exposed to the outside.

The second sliding block 400 includes a second front surface 401 and a second back surface 402. In at least one embodiment, the second sliding block 400 defines two second through holes 403 passing through the second front surface 401 and the second back surface 402.

Each second insert core 60 includes a tail portion 62 and an insert portion 64. Each second insert core 60 is inserted through the second sliding block 400, such that the insert portion 64 is received in the second through hole 403 and protrudes out of the second front surface 401, and the tail portion 62 abuts the second back surface 402.

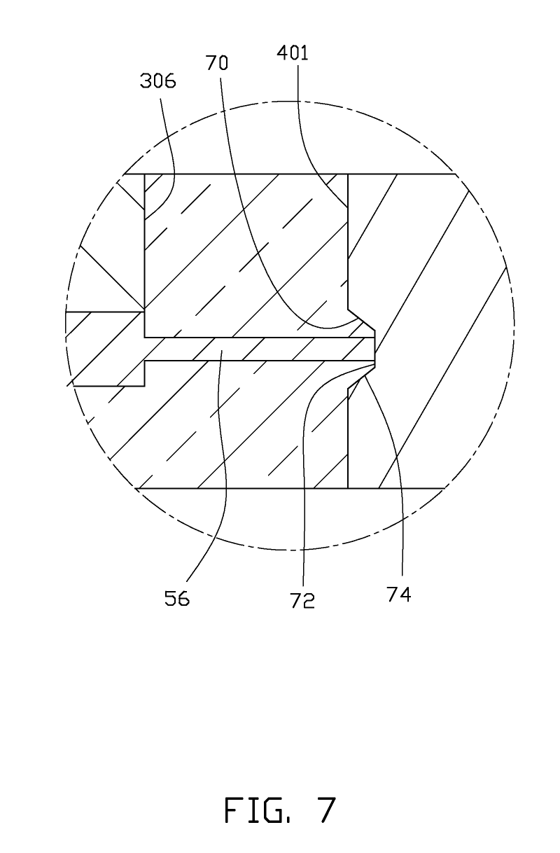

The second sliding block 400 further defines two shrinkage holes 70 in the second front surface 401 for molding the protrusions 20. The two shrinkage holes 70 are located between the two second through holes 403. Each shrinkage hole 70 is substantially circular and a truncated cone shape. Each shrinkage hole 70 includes a bottom portion 72 and a slant side-wall 74 (both shown in FIG. 7). The penetrating portion 56 of each first insert core 50 inserts into the corresponding shrinkage hole 70 and contacts the bottom portion 72.

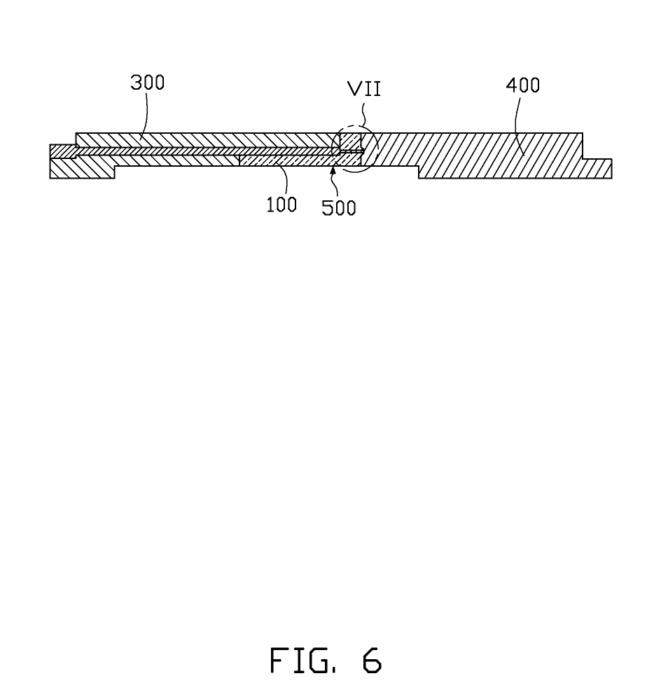

FIG. 6 illustrates a method for manufacturing the optical fiber connector 100 using the mold 30.

An alternative embodiment, the mold 30 of FIG. 4 can be provided. The two first insert cores 50 are inserted into the first sliding block 300, and the two second insert cores 60 are inserted into the second sliding block 400. The first sliding block 300 and the second sliding block 400 cooperatively define a molding space 500 therebetween for molding the optical fiber connector 100, and the first front surface 306 faces toward the second front surface 401. A shape of the molding space 500 substantially matches a shape of the optical fiber connector 100.

Molten plastic is injected into the molding space 500. The molding portion 304 and the portions of the main portions 54 received in the molding holes are configured to cooperatively define the recess 160 and the receiving groove 122. The penetrating portion 56 is configured to define the receiving hole 124 and the hole 210. The penetrating portion 56 and the shrinkage hole 70 are configured to cooperatively mold the protrusion 20. The insert portion 64 protrudes out from the second front surface 401 so as to define the locating hole 128 in the optical fiber connector 100.

The molded plastic is then cooled to form the optical fiber connector 100.

The molded optical fiber connector 100 is separated from the mold 30.

The above-described optical fiber connector includes protrusions and each protrusion surrounds the receiving hole which is configured to receive optical fiber. When molding the optical fiber connector, the molten plastic has better mobility in the shrinkage hole, so shrinkage may not happen on the first surface around the receiving hole of the optical fiber connector. In this way, the receiving hole of the optical fiber connector may have better quality.

Although numerous characteristics and advantages of the present embodiments have been set forth in the foregoing description, together with details of the structures and functions of the embodiment, the disclosure is illustrative only, and changes may be made in detail, including in the matters of shape, size, and the arrangement of parts within the principles of the disclosure to the full extent indicated by the broad general meaning of the terms in which the appended claims are expressed.

What is claimed is:

1. An optical fiber connector comprising:
a main body comprising:
a first surface;
a second surface opposite to the first surface;
an upper surface having a recess defined therein and the recess passing through the second surface;
a lower surface opposite to the upper surface, wherein at least one receiving hole being formed in the first surface and being configured for fluid communication with the recess; and
at least one protrusion corresponding to the receiving hole, each of the at least one protrusion being positioned on the first surface and surrounding an opening of the corresponding receiving hole in the first surface.

2. The optical fiber connector of claim 1, wherein the protrusion axially defines a hole, the hole fluidly communicates with the corresponding receiving hole, a diameter of the hole is substantially the same a diameter of the receiving hole.

3. The optical fiber connector of claim 1, wherein the protrusion is a substantially circular truncated cone.

4. The optical fiber connector of claim 1, wherein the recess includes a bottom surface substantially parallel to the upper surface and a connecting surface substantially perpendicularly connected between the bottom surface and the upper surface, the receiving hole passing through the first surface and the connecting surface.

5. The optical fiber connector of claim 4, wherein the main body defines at least one receiving groove in the bottom surface corresponding to the receiving hole, the receiving groove passes through the second surface and extends to the connecting surface, each receiving groove is aligned to the corresponding receiving hole.

6. The optical fiber connector of claim 5, wherein a cross-section of each receiving groove is substantially semi-circular and each receiving hole is substantially circular, a diameter of each receiving hole is smaller than a diameter of each receiving groove.

7. The optical fiber connector of claim 1, wherein the main body defines two locating holes in the first surface, and the protrusion is positioned between the two locating holes.

8. A mold for manufacturing an optical fiber connector, the optical fiber connector comprising a main body and at least one protrusion, the main body comprising a first surface, a second surface opposite to the first surface, an upper surface having a recess defined therein and a lower surface opposite to the upper surface, wherein the recess passing through the second surface and at least one receiving hole being formed in the first surface and being configured for fluid communication with the recess; the at least one protrusion corresponding to the receiving hole, each of the at least one protrusion being positioned on the first surface and surrounding an opening of the corresponding receiving hole in the first surface; the mold comprising:
a first sliding block;
a second sliding block facing the first sliding block, the second sliding block defines at least one shrinkage hole in one surface which is facing the first sliding block, each shrinkage hole comprising a bottom portion, the first sliding block and the second sliding block cooperatively form a molding space therebetween; and
at least one first insert core passing through the first sliding block each first insert core comprising a main portion and a penetrating portion extended from the main portion, a portion of the main portion is exposed to outside from the first sliding block, the penetrating portion is exposed to outside from the first sliding block, the penetrating portion inserting into the corresponding shrinkage hole and contacting with the bottom portion.

9. The mold of claim 8, wherein the shrinkage hole is substantially circular and truncated cone-shaped.

10. The mold of claim 8, wherein the mold comprises two second insert cores, the two second insert cores are inserted into the second sliding block and protrude out from the second sliding block toward the first sliding block.

11. A method for manufacturing an optical fiber connector, the optical fiber connector comprising a main body and at least one protrusion, the main body comprising a first surface, a second surface opposite to the first surface, an upper surface having a recess defined therein and a lower surface opposite to the upper surface, wherein the recess passing through the second surface and at least one receiving hole being formed in the first surface and being configured for fluid communication with the recess; the at least one protrusion corresponding to the receiving hole, each of the at least one protrusion being positioned on the first surface and surrounding an opening of the corresponding receiving hole in the first surface; the method comprising:
providing a mold, the mold comprising:
a first sliding block;
a second sliding block facing the first sliding block, the second sliding block defines at least one shrinkage hole in one surface which is facing the first sliding block, each shrinkage hole comprising a bottom portion, the first sliding block and the second sliding block cooperatively form a molding space therebetween; and
at least one first insert core passing through the first sliding block, each first insert core comprising a main portion and a penetrating portion extended from the main portion, a portion of the main portion is exposed to outside from the first sliding block, the penetrating portion is exposed to outside from the first sliding block, the penetrating portion inserting into the corresponding shrinkage hole and contacting with the bottom portion;
injecting molten plastic into the molding space;
cooling the plastic to form the optical fiber connector;
separating the molded optical fiber connector from the mold.

12. The method of claim 11, wherein the shrinkage hole is substantially circular and truncated cone-shaped.

13. The method of claim 11, wherein the mold comprises two second insert cores, the two second insert cores are inserted into the second sliding block and protrude out from the second sliding block toward the first sliding block.
